(19) United States
(12) Patent Application Publication
(10) Pub. No.: US 2008/0181393 A1
(43) Pub. Date: Jul. 31, 2008

(54) METHODS AND APPARATUS TO MAINTAIN COMMUNICATION SERVICES DURING A POWER FAILURE

(76) Inventors: Ronald Brost, Danville, CA (US); Goangshiuan Shawn Ying, Oakland, CA (US); Stephen Aspell, Brentwood, CA (US); Eugene L. Edmon, Danville, CA (US); Renee C. Estes, Danville, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/627,821

(22) Filed: Jan. 26, 2007

(51) Int. Cl. H04M 1/00

(52) U.S. Cl. 379/413

(57) ABSTRACT

Methods and apparatus to maintain communication services during a power failure are disclosed. An example method comprises detecting a loss of power at a digital subscriber line (DSL) modem and detecting a power status of the DSL modem. The example method also includes, when the power status is in an on state, transmitting a message indicative of the on state of the power status along a subscriber line to a digital subscriber line access multiplexer (DSLAM).

### FIELD OF THE DISCLOSURE

This disclosure relates generally to telecommunications and, more particularly, to methods and apparatus to maintain communication services during a power failure.

### BACKGROUND

Broadband communication services continue to appear in households at increasing rates. Such services provide high speed Internet services, high speed video services, streaming audio services, and/or telephone services. Generally speaking, digital subscriber lines (DSL) facilitate delivery of these, and other, services to subscribers in various households. The DSL services are typically deployed using legacy/conventional twisted pair cables that were installed over the last few decades as part of the public switched telephone network (PSTN) that were, originally, designed to carry plain old telephone services (POTS).

The telephone services delivered by the PSTN allowed subscribers to send and receive telephone calls, in which the telephones were powered by the PSTN network rather than utilize line power provided by each household. As such, in the event of a local power outage in the subscriber's home, telephone services would not be affected, thereby allowing emergency calls to be sent and/or received by members of the household. However, while the recent deployment of broadband services via DSL uses the PSTN twisted pair lines, each household powers a DSL modem via local household line power. As a result, if local power is disrupted by, for example, a weather related incident, then communication services for that household will be unavailable.

Some DSL service providers employ one or more power supplies at a central office (CO) and/or one or more relay banks to provide power to a subscriber in the event of a localized power outage at the household. However, the number of available power supplies at the CO and the ability to provide adequate power to a large number of subscribers is both limited and expensive to facilitate.

### BRIEF DESCRIPTION OF THE DRAWINGS

FIG. 1 is a schematic diagram of an example system constructed in accordance with the teachings of the invention to maintain communication services during a power failure.

FIGS. 2A, 2B, and 3 are flow diagrams representative of example machine readable instructions which may be executed to maintain communication services during a power failure of FIG. 1.

FIG. 4 is a schematic illustration of an example computer which may execute the programs of FIGS. 2A, 2B, and/or 3 to implement the example DSL modem and/or the example DSLAM of FIG. 1.

### DETAILED DESCRIPTION

Methods and apparatus to maintain communication services during a power failure are disclosed. An example method comprises detecting a loss of main power at a digital subscriber line (DSL) modem and detecting a power status of the DSL modem. The example method also includes, when the power status is in an on state, transmitting a message indicative of the on state of the power status along a subscriber line to a digital subscriber line access multiplexer (DSLAM).

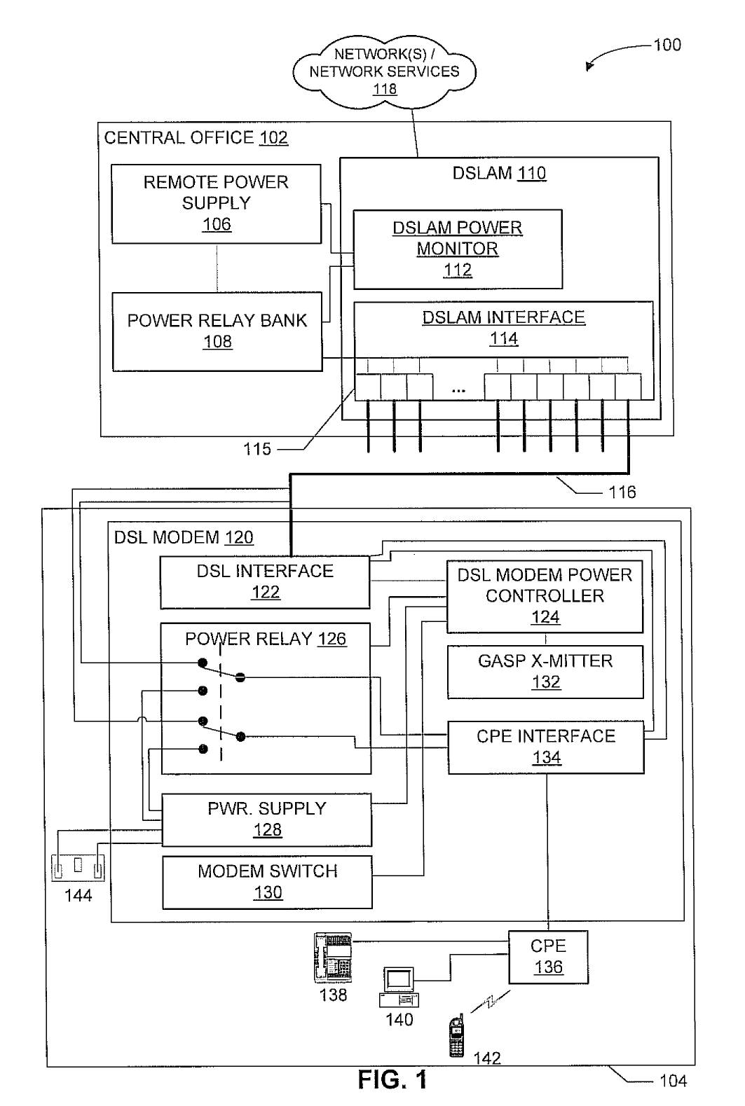

FIG. 1 is a schematic illustration of an example digital subscriber line (DSL) communication system 100 to maintain communication services during a power failure. More specifically, the example system 100 includes a central office (CO) 102 to provide various information services to a household 104. Information services may include, but are not limited to, high speed data services, intranet services, Internet services, and/or telephone services, such as voice over Internet protocol (VoIP) services and/or voice over DSL (VoDSL) services. In the illustrated example system 100 of FIG. 1, the CO includes a remote power supply 106, a power relay bank 108, and a digital subscriber line access multiplexer (DSLAM) 110. The DSLAM 110 includes a DSLAM power monitor 112 and a DSL interface 114 that is communicatively connected to one or more subscriber lines (e.g., twisted pair loops) 116, each of which terminate at a household 104. In the illustrated example communication system 100, the remote power supply 106 is electrically routed to the power relay bank 108. Based on control signals transmitted by the DSLAM power monitor 112, the power relay bank 108 routes power from the remote power supply 106 to one or more nodes 115 of the example DSLAM interface 114. Each one of the plurality of nodes 115 is electrically and/or communicatively connected to a respective household (e.g., the household 104) via a respective subscriber line 116.

In operation, the example DSLAM 110 uses the subscriber lines 116, such as twisted pair telephone lines from a plain old telephone system (POTS) network, to provide various high speed services to one or more subscribers at one or more households 104. In the illustrated example, the DSLAM 110 aggregates information from a network 118, such as a corporate network and/or the Internet. Without limitation, the network 118 may include data services and/or voice communication services. The example DSLAM 110 multiplexes both voice and data services over the respective subscriber lines 116 for the households 104 in accordance with the requested communication services. Each DSLAM 110 may accommodate any number of subscriber lines 116 via one or more DSL interfaces 114, wherein each DSL interface 114 may accommodate, for example, thirty-two subscriber lines 116. Persons having ordinary skill in the art will appreciate that each DSLAM 110 may have several DSL interfaces 114, each of which accommodate a plurality of twisted pair loops 116.

While disclosed examples discussed herein utilize session initiation protocol (SIP) exchanges, messages and/or techniques to initiate, establish and/or modify VoIP and/or VoDSL communication sessions and/or data transfer sessions, any number and/or type(s) of past, present and/or future communication protocol(s), message(s), exchange(s) and/or technique(s) for initiating, establishing and/or modifying communication sessions and/or data transfer sessions may be utilized. For example, any past, current and/or future media gateway control protocol (MGCP) standard and/or specification, such as the International Telecommunication Union (ITU) H.248 standard may be employed.

In the example communication system illustrated in FIG. 1, call processing system(s) are implemented using an architecture commonly referred to in the industry as a “soft-switch architecture” in that a first server (e.g., a media gateway) implements the actual transmitting, receiving and/or transcoding of communication session data, while a second server (e.g., a media gateway controller) implements the signaling, control, logic and/or protocol(s) to initiate, route and/or establish VoIP communication sessions. However, any type(s) of call processing system architecture(s) may additionally or alternatively be implemented. For example, the call processing system(s) may be implemented in accordance with a past, current and/or future 3^{rd} Generation Partnership Program (3GPP) Internet Multimedia Subsystem (IMS) standard and/or specification, and/or may be implemented using, for example, session border controllers, call processors, call serving controllers, etc. Furthermore, DSL services deployed on the example communication system 100 may be of any type including, but not limited to, high rate DSL (HDSL), symetric DSL (SDSL), asymmetric DSL (ADSL), rate adaptive DSL (RADSL), and/or very high bit rate DSL (VDSL).

The example household 104 includes a DSL modem 120 to receive the services provided by the example DSLAM 110 in the CO 102. In the illustrated example, the DSL modem 120 includes a DSL interface 122, a DSL modem power controller 124, a power relay 126, a power supply 128, a DSL modem power switch 130, a gasp transmitter 132, and a consumer premises equipment (CPE) interface 134. The example DSL interface 122 of the DSL modem 120 receives and transmits voice and data information from/to the example DSLAM 110 via the subscriber line (e.g., a twisted pair loop) 116. The DSL interface 122 is communicatively connected to the CPE interface 134, which is communicatively connected to one or more CPE devices 136, such as a VoIP telephone 138, a personal computer (PC) 140, and/or a WiFi phone 142. The example power relay 126 of the DSL modem 120, under normal operating conditions, receives input (source) power for the DSL modem from the power supply 128. However, the power relay 126 is adapted to switch its input power connection to the subscriber line 116 in the event that the power supply fails and/or line power of the example household 104 is lost.

In the illustrated example of FIG. 1, the power relay 126 includes a double pole, double throw (DPDT) switch. Persons having ordinary skill in the art will appreciate that the DPDT switch may be either normally open or normally closed, wherein an electrical current activates the switch in the opposite direction. To conserve power during situations in which auxiliary power is needed, the switch of the example power relay 126 operates in an un-energized position to facilitate auxiliary power routing from the subscriber line 116 to the DSL modem 120 and/or CPE interface 134. While the example power relay 126 of FIG. 1 illustrates physical switch relays (e.g., the DPDT switch), persons having ordinary skill in the art will appreciate that solid state switches may additionally or alternatively be employed to route power to the DSL modem 120 and/or CPE interface 134. For example, the power relay 126 may employ a field effect transistor (FET) to route source power from either the power supply 128 or the CO 102. FETs are particularly attractive devices for power switching because they typically exhibit a low power drain during operation (i.e., a low I²R loss), unlike a relay that energizes a physical relay via one or more magnetic coils.

The example power supply 128 of FIG. 1 includes a power line connector 144 that receives electrical line power from a commercial power supply at the household 104, such as a 60 Hz alternating current of 120 volts. The DSL modem power controller 124 monitors the power supply 128 to verify that line power from the line connector 144 is adequate for the functions of the DSL modem 120 and/or the CPEs 136 connected thereto. In the event that the line power to the connector 144 is lost or sufficiently degraded, the DSL modem power controller 124 determines whether the loss of power was due to an intentional act via the DSL modem power switch 130. In the illustrated example of FIG. 1, the modern power switch 130 may be implemented as a physical push-button, momentary-button or rocker switch to connect and/or disconnect commercial line power. Persons having ordinary skill in the art will appreciate that the modem power switch 130 may, alternatively, connect and/or disconnect DC power from the power supply 128 instead of connecting and/or disconnecting AC power from the power line connector 144. Additionally or alternatively, the modern power switch 130 may be employed as a button that toggles a power status bit of the example DSL modem 120. For example, if the DSL modem user depresses or otherwise interfaces with the DSL modem power switch 130, a power status bit of the DSL modem power controller 124 is set to a logic TRUE or a logic FALSE. As discussed in further detail below, the power status bit state may be sent by the DSL modern power controller 124 to the DSLAM power monitor 112 and/or the DSLAM power monitor 112 may query the DSL modem power status bit state to determine whether the user intended the DSL modem to remain in a powered-on or a powered-off state.

If the power switch 130 is still in an “ON” position (and/or if the power status bit it TRUE), then power may have been lost due to, for example, a weather related incident. However, if the DSL modem power controller 124 determines that the DSL modem power switch 130 is in an “OFF” position (and/or if the power status bit is FALSE), then no further action(s) is taken by the DSL modem power controller 124.

A power loss due to, for example, a strong wind storm, causes the DSL modem power controller 124 to transmit a dying gasp message to the DSLAM 110 via the gasp transmitter 132 that is communicatively connected to the subscriber line 116. As discussed in further detail below, some power outages may be intermittent and not require that auxiliary power be delivered to the example DSL modem 120 by the CO 102. In such cases, the DSL modem power controller 124 employs a timer with a predetermined time limit. If such time limits are exceeded, then the power outage may be deemed sufficient to be worthy of implementation of auxiliary power activation. In that case, the DSL modem power controller 124 sends a control signal to the power relay 126 to switch incoming power from the power supply 128 to the subscriber line 116. Additionally, the DSL modem power controller 124 reduces the power demands of the DSL modem 120 and/or any CPEs 136 connected thereto by causing the DSL modem 120 to deactivate unnecessary ports. Persons having ordinary skill in the art will appreciate that the DSL modem 120 may employ numerous ports for VoIP packets and data packets. Services delivered by a service provider to a household subscriber may include deployment of any number of channels and/or virtual circuits. For example, deployed broadband network services 118 may include one or more channels for uploading, for downloading, for fast channel services (e.g., streaming multimedia), and/or for interleaved services (e.g., for file transfers where transmission errors are not acceptable). During normal operation, ports and/or channels that accommodate both VoIP and data packets are typically enabled because power consumption by the DSL modem is accomplished solely by the local commercial power supply. However, if the DSL modem 120 needs to utilize auxiliary power provided by the CO 102 via the subscriber line 116, then the power saving techniques of the DSL modem 120 (e.g., disabling some ports and/or services) reduce tile burden on the CO 102 to provide power to tile households and/or subscribers.

Generally speaking, auxiliary power backup equipment (e.g., the remote power supply 106, the power relay bank 108, etc.) is expensive to implement, control, and/or maintain. Additionally, the remote power supply 106 may not be capable of fully supporting tile power requirements of all subscribers. Instead, cost constraints may dictate that the remote power supply be capable of supporting power needs for a fraction of the households on the example communication system 100. Similarly, the example power relay bank 108 may only have a finite number of switch destination points rather than one dedicated switch route to the remote power supply 106 for every household 104. As such, restricting power demands of the DSL modem(s) 120 in at least some of the households 104 helps to constrain such costs.

Generally speaking, a fewer number of ports and/or channels operating on a DSL modem 120 results in a lower power demand. Of particular importance to subscribers of DSL services is the ability to send and receive emergency telephone calls. In the event of a power outage, implementing auxiliary power sources for the DSL modem 120 allows the subscriber to place emergency calls, as needed. However, the DSL modem power controller 124 of the illustrated example restricts any use of at least some of the data ports, channels, and/or secondary voice ports when the household power is out. Additionally or alternatively, the DSL modem power controller 124 may cause the overall clock speed of the DSL modem 120 to drop to a lower frequency, thereby conserving power consumed by the DSL modem 120.

While the DSL modem power controller 124 of the example DSL modem 120 of FIG. 1 sends signals to control port/channel activation, to control port/channel deactivation, and/or to control clock speed, the example DSLAM power monitor 112 of the example DSLAM 110 may, additionally or alternatively, send such control signals to the DSL modem 120 via the subscriber line 116. For example, upon receipt of the gasp message from the gasp transmitter 132, the DSLAM power monitor 112 may transmit a control signal to the power relay bank 108 to route power to the DSL modem 120. Additionally or alternatively, the DSLAM power monitor 112 may transmit one or more control signals to tile DSL modem 120 to, for example, disable some or all data ports/channels, disable all but a single voice port/channel, and/or reduce the DSL modem 120 clock speed to conserve power consumption requirements.

Additionally or alternatively, auxiliary power may be routed to the user's DSL modem 120 after a power outage (e.g., a wind storm) as a result of subscribing to a premium service. For example, the DSLAM power monitor 112 may receive a dying gasp message from the gasp transmitter 132 that includes power status information (e.g., a modem switch 130 position and/or a power bit status) and user identification information (e.g., a user account number, a user telephone number, a DSL modem MAC address, etc.). In the illustrated example of FIG. 1, upon receipt of the user identification information, the DSLAM power monitor 112 queries a customer database to determine if the user has subscribed to the premium service to receive auxiliary power during local power outages. If the user is a premium subscriber, then the DSLAM power monitor 112 instructs the power relay bank 108 to route power to the user's DSL modem 120.

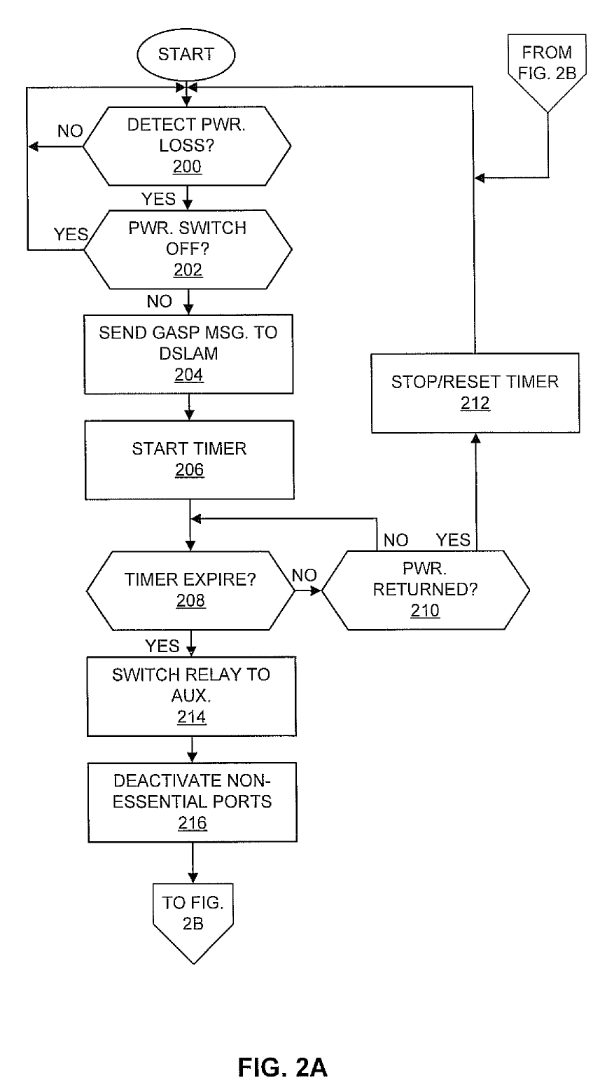

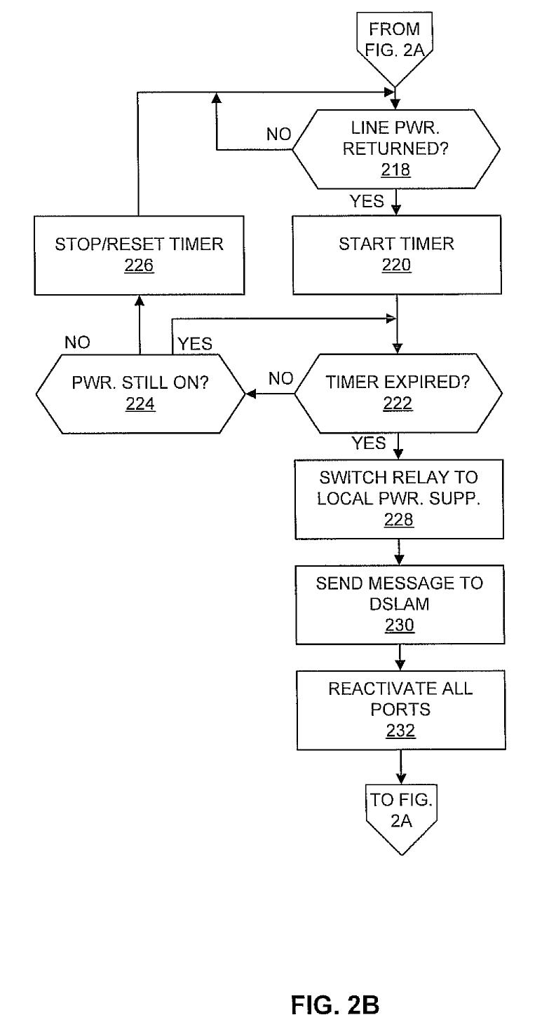

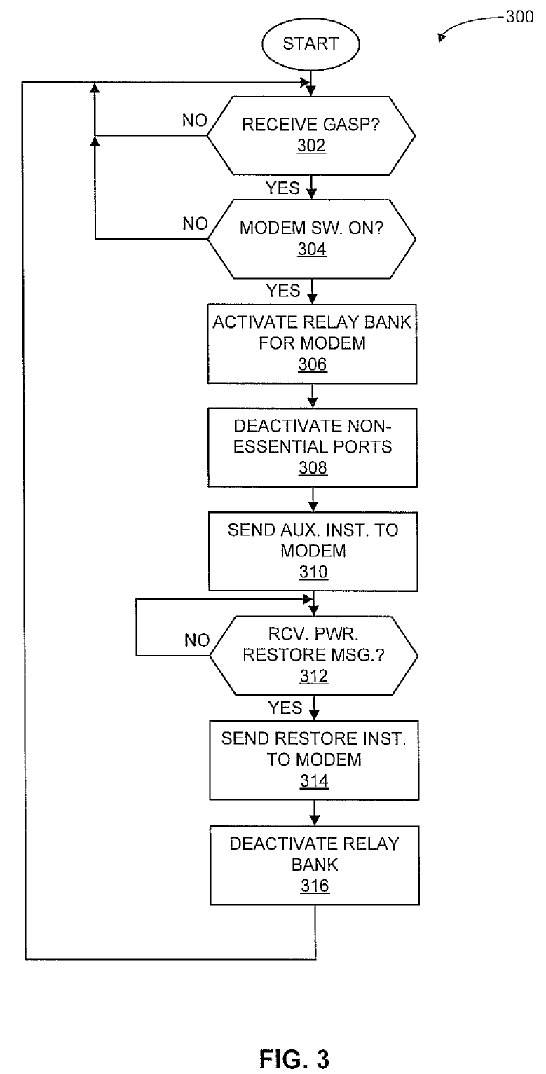

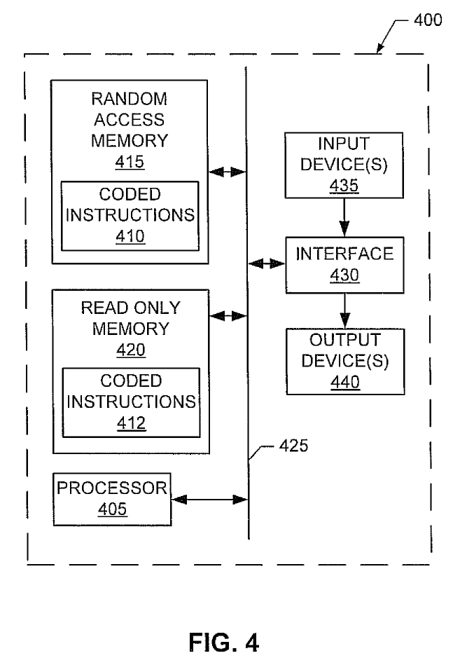

Flowcharts representative of example machine readable instructions for implementing the example system 100 to maintain communication services during a power failure FIG. 1 is shown in FIGS. 2A, 2B and 3. In these examples, the machine readable instructions comprise a program for execution by: (a) a processor such as the processor 405 shown in the example computer 400 discussed below in connection with FIG. 4, (b) a controller, and/or (c) any other suitable processing device. The program may be embodied in software stored on a tangible medium such as, for example, a flash memory, a CD-ROM, a floppy disk, a hard-drive, a digital versatile disk (DVD), or a memory associated with the processor 405, but persons of ordinary skill in the art will readily appreciate that the entire program and/or parts thereof could alternatively be executed by a device other than the processor 405 and/or embodied in firmware or dedicated hardware (e.g., it may be implemented by an application specific integrated circuit (ASIC), a programmable logic device (PLD), a field programmable logic device (FPLD), discrete logic, etc.). For example, any or all of the system 100 to maintain communication services during a power failure, the DSLAM power monitor 112, the DSL modem power controller 124, and/or the gasp transmitter 132 could be implemented by software, hardware, and/or firmware. Also, some or all of the machine readable instructions represented by the flowcharts of FIGS. 2A, 2B, and 3 may be implemented manually. Further, although the example program is described with reference to the flowcharts illustrated in FIGS. 2A, 2B, and 3, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The program of FIG. 2A begins at block 200 where the example DSL modem 120 in the example system 100 of FIG. 1 detects a power disturbance event (e.g., a power failure). As described above, the DSL modem 120 includes a DSL modem power controller 124 operatively connected to the power supply 128 to monitor voltage and/or current input and/or output of the power supply 128. For example, the DSL modem power controller 124 may employ current sensors (e.g., hall effect sensors) to monitor an alternating current input line from the power line connector 144 to determine whether sufficient current is present from the electrical line power of the household 104. Additionally or alternatively, the DSL modem power controller 124 may employ one or more voltage sensors/transducers to determine whether appropriate household 104 line voltage is present and/or whether the power supply 128 is delivering sufficient output parameters (e.g., sufficient voltage and/or current) to the DSL modem 120 and/or CPEs 136 (e.g., the VoIP phone 138). In the event that line power from the example household 104 is sufficient, the DSL modem power controller 124 may determine that the power supply has failed, thereby allowing power to be provided by the CO 102 via the subscriber line 116. Accordingly, the DSL modem power controller 124 may transmit an error condition that alerts the homeowner and/or service provider that the power supply 128 has failed, thereby allowing a service call to be generated.

If the DSL modem power controller 124 determines that the power supply is no longer delivering power (block 200), and that the power switch (e.g., the DSL modem switch 130) is in the “OFF” position (block 202), then the DSL modem power controller 124 continues to monitor for power interruptions (block 200). On the other hand, if the power switch is in the “ON” position (block 202), then the DSL modem power controller 124 invokes the gasp transmitter 132 to send a message to the CO 102 that auxiliary power is needed (block 204). Persons having ordinary skill in the art will appreciate that the example gasp transmitter 132 may be communicatively connected to the example CO 102 via communicative connections through the DSL modem power controller 124, through the DSL interface 122, and/or through the subscriber line 116.

Because power interruptions to the example household 104 may be intermittent and/or resolved rather quickly, the example DSL modem power controller 124 initiates a timer (block 206) having a predetermined expiration time. Persons having ordinary skill in the art will appreciate that the timer duration may be preset during the manufacturing process of the example DSL modem 120, and/or modified by the service provider (e.g., during a service call or from a remote location). If the timer has not expired (block 208) and the power has not been restored (block 210), then the DSL modem power controller 124 continues to wait (block 208). However, if the example DSL modem power controller 124 detects that the power has been restored (block 210), then the timer is stopped and reset (block 212), and the DSL modem power controller 124 continues to monitor for power supply 128 anomalies.

If the power has not been restored (block 210) and the timer expires (block 208), then the DSL modem power controller 124 sends a control signal to the power relay 126 to receive power from the subscriber line 116 rather than the the power supply 128 (block 214). To minimize the amount of power that the CO 102 must provide, the example DSL modem 120 deactivates any non-essential ports (block 216), such as all data ports and/or all secondary and/or tertiary voice ports. As a result, the user in the example household 104 will no longer be able to send and/or receive data packets, such as data packets sent and/or received when using a web-browser with the Internet. However, the user of the example household 104 will still have at least one active voice port that functions to facilitate telephone calls with the CPE 136, such as the example VoIP telephone 138.

Wile in an auxiliary power use mode, the example DSL modem power controller 124 continues to monitor the power supply 128 for a return of supply power (block 218), as shown in FIG. 2B. Upon detecting that power has been restored (block 218), the DSL modem power controller 124 starts a timer (block 220) in an effort to verify that the power restoration is not likely to be temporary. For instance, during times of power outage, electrical service personnel may cause line power of the example household 104 to turn on and off intermittently. Such temporary periods of available power may continue for several minutes, several hours, and/or several days. To minimize repeated switch contact activity of the example power relay 126 and maximize VoIP service availability, the example DSL modem power controller 124 determines that any restored power is available for a significant amount of time before removing the auxiliary power. If the timer has not expired (block 222) and the line power of the household is still on (block 224), then the DSL modem power controller continues to wait (block 222). However, if the household power is no longer present (block 224), which is indicative of the intermittent effects of, for example, electrical service personnel (e.g., the local electric company), then the timer is stopped and reset (block 226) and the DSL modem 120 continues to consume auxiliary power provided by the CO 102 while monitoring for the return of line power (block 218).

On the other hand, if the timer expires (block 222) when commercial power is still present at the household 104, then the previous power loss is deemed to be over. The DSL modem power controller 124 then sends a control signal to the example power relay 126 to receive power from the power supply 128 instead of the subscriber line 116 (block 228), and a message is sent to the DSLAM 110 of the CO 102 indicating that power has been restored to the DSL modem 120 (block 230). Additionally, any ports that were previously deactivated are activated (block 232).

FIG. 3 illustrates an example program 300 by which the example DSLAM power monitor 112 of the example DSLAM 110 monitors one or more DSL modems (such as the example DSL modern 120 of the household 104) for a power loss. Beginning at block 302, the DSLAM power monitor 112 determines whether a gasp message is received from the DSL modem 120 (block 302) and extracts information within the gasp message indicative of the power switch position of the DSL modem 120 (block 304). If the information indicative of switch position indicates that the power switch 130 of the DSL modem 120 is in the “OFF” position (and/or that the power status bit is FALSE), then the example DSLAM power monitor 112 continues to monitor the DSL interface 114 for instances of a power outage (block 302). However, if the information indicative of switch position indicates that the power switch 130 of the DSL modem 120 is in the “ON” position (and/or that the power status bit is TRUE) (block 304), then the DSLAM power monitor 112 sends a control signal to the power relay bank 108 to route power to the appropriate DSL modem 120 (block 306). Additionally, the DSLAM power monitor 112 sends a control signal to the remote power supply 106 to apply power parameters sufficient for the DSL modem 120 and any other serviceable device that is experiencing a power outage.

The DSLAM power monitor 112 of the illustrated example sends power to the target DSL modem 120 via the example power relay bank 108, and also sends a control signal to the DSL modem 120 to deactivate all non-essential ports to conserve power consumption requirements. As described above, power consumption requirements of the example DSL modem 120 may be reduced by deactivating one or more ports, reducing bandwidth transmission rates between the DSL modem and the DSLAM 110, and/or reducing a clock speed of the DSL modem 120. Persons having ordinary skill in the art will appreciate that the example DSL modem 120 may have an on-board processor, such as the example DSL modem power controller 124, to automatically employ power reduction procedures, thereby reducing or eliminating the need for the DSLAM power monitor 112 to send such commands. In the illustrated example process 300 of FIG. 3, the DSLAM power monitor 112 sends a control signal to the DSL modem 120 to adjust the power relay 126 so that power is received from the subscriber line 116 rather than the power supply 128 (block 310). Again, persons having ordinary skill in the art will appreciate that one or more of the example processes of FIG. 3 (e.g., the signals to set the position of the relay 126) may be eliminated in the event that the DSL modem contains a processor to perform such example functions. However, for the sake of illustration, the example process 300 of FIG. 3 assumes that control signals to employ power saving techniques and switch input power sources is performed by the DSLAM power monitor 112. Again, one or more operations may be eliminated from the instructions represented by FIGS. 2A, 2B and/or 3 to avoid redundancies as desired based on the capabilities of the implemented modem.

In the illustrated example process 300 of FIG. 3, the DSLAM power monitor 112 monitors for a message that power has been restored at the example DSL modem 120 (block 312). If no such message is received, the DSLAM power monitor 112 continues to wait for a power-restored signal, while continuing to supply auxiliary power to the DSL modem 120 (block 312). However, if a message is received that power has been restored at tile DSL modem 120 (block 312), then in the example of FIG. 3, the DSLAM power monitor 112 sends a control signal to the DSL modem 120 to restore all previously deactivated ports and/or increase the clock speed of the example DSL modem 120 (block 314). Additionally, the DSLAM power monitor 112 sends a control message to the power relay 126 of the DSL modern 120 to receive power from the power supply 128 rather than the subscriber line 116. Control returns to block 302 to continue to monitor one or more DSL modems for a gasp message.

FIG. 4 is a schematic diagram of an example processor platform 400 that may be used and/or programmed to execute some or all of the instructions represented by FIGS. 2A, 2B, and 3 to implement all or a portion of the example DSLAM power monitor 112, the DSL modem power controller 124, and/or the gasp transmitter 132 of FIG. 1. For example, the processor platform 400 can be implemented by one or more general purpose processors, processor cores, microcontrollers, etc.

The processor platform 400 of the example of FIG. 4 includes at least one general purpose programmable processor 405. The processor 405 executes coded instructions 410 and/or 412 present in main memory of the processor 405 (e.g., within a RAM 415 and/or a ROM 420). The processor 405 may be any type of processing unit, such as a processor core, a processor and/or a microcontroller. The processor 405 may execute, among other things, the example machine accessible instructions of FIGS. 2A, 2B, and 3 to maintain communication services during a power failure. The processor 405 is in communication with the main memory (including a ROM. 420 and/or the RAM 415) via a bus 425. The RAM 415 may be implemented by DRAM, SDRAM, and/or any other type of RAM device, and ROM may be implemented by flash memory and/or any other desired type of memory device. Access to the memory 415 and 420 maybe controlled by a memory controller (not shown). The processor platform 400 also includes an interface circuit 430. The interface circuit 430 may be implemented by any type of interface standard, such as an external memory interface, serial port, general purpose input/output, etc. One or more input devices 435 and one or more output devices 440 are connected to the interface circuit 430.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to maintain communication services during a power failure, the method comprising;
detecting a loss of power at a digital subscriber line (DSL) modem;
detecting a power status of the DSL modem; and
when the power status is in an on state, transmitting a message indicative of the power status along a subscriber line to a digital subscriber line access multiplexer (DSLAM).

2. A method as defined in claim 1, wherein the power status is detected by a switch position of the DSL modem or a power bit status of the DSL modem.

3. A method as defined in claim 1, further comprising receiving auxiliary power from the DSLAM via the subscriber line.

4. A method as defined in claim 3, wherein the auxiliary power is received after a dwell period to determine if the loss of power was temporary.

5. A method as defiled in claim 3, wherein the DSL modem enters a power save mode in response to the loss of power.

6. A method as defined in claim 5, wherein the power save mode comprises at least one of reducing a clock rate of the DSL modem, reducing a data rate for a data line, reducing a quantity of active data lines, or reducing a quantity of active voice lines.

7. A method as defined in claim 3, further comprising detecting a return of power.

8. (canceled)

9. A method as defined in claim 7, further comprising transmitting a message to the DSLAM that power has been restored.

10. A method as defined in claim 7, further comprising exiting a power save mode of the DSL modem in response to detecting power.

11. A method as defined in claim 3, wherein auxiliary power is received if the DSL modem is associated with a premium subscriber.

12. A method to maintain communication services during a power failure, the method comprising:
receiving a dying gasp message from a digital subscriber line (DSL) modem via a subscriber line, the message including DSL modem power switch position information;
determining a power status of the DSL modem; and
when the DSL modem power status is on, starting a first timer having a first duration.

13. A method as defined in claim 12, wherein the power status of the DSL modem is determined by a DSL modem switch position or a DSL modem power bit status.

14. A method as defined in claim 12, further comprising providing power to the DSL modem via the subscriber line when the first timer has exceeded the first duration.

15. A method as defined in claim 14, further comprising transmitting power save-mode instructions to the DSL modem, the power save-mode instructions comprising at least one of reducing a clock rate of the DSL modem, disabling a DSL modem data line, or disabling a DSL modem port.

16. A method as defined in claim 14, further comprising blocking a data line or a voice line.

17. A method as defined in claim 12, further comprising starting a second timer having a second duration upon receipt of a power restoration message from tile DSL modem.

18. A method as defined in claim 17, wherein if the second timer has exceeded the second duration, transmitting power normal-mode instructions to the DSL modem, the power normal-mode instructions comprising at least one of increasing a clock rate of the DSL modem, enabling a DSL modem data line, or enabling a DSL modem port.

19. (canceled)

20. An apparatus to maintain communication services during a power failure comprising:
a digital subscriber line (DSL) modem power supply;
a DSL modem power switch; and
a DSL modem power controller to monitor an output of the DSL modem power supply and a power status of the DSL modem.

21. An apparatus as defined in claim 20, wherein the DSL modem power controller monitors a power switch position of the DSL modem or a power bit status of the DSL modem.

22. An apparatus as defined in claim 20, further comprising a gasp transmitter to transmit information indicative of a power loss in response to a loss of power at the DSL modem power supply.

23. (canceled)

24. An apparatus as defined in claim 22, wherein the gasp transmitter transmits an indication of the position of a power switch of the DSL modem.

25. An apparatus as defined in claim 20, further comprising a DSL modem power relay to supply power from the DSL modem power supply or an auxiliary power source.

26-48. (canceled)
